(19) United States
(12) Patent Application Publication
(10) Pub. No.: US 2015/0286089 A1
(43) Pub. Date: Oct. 8, 2015

(54) LIQUID-CRYSTAL DISPLAY DEVICE

(71) Applicant: Japan Display Inc., Minato-ku (JP)

(72) Inventors: Ayano SOEJIMA, Minato-ku (JP); Kazuyuki Sunohara, Minato-ku (JP); Daigo Fujita, Minato-ku (JP); Shin Morita, Minato-ku (JP)

(73) Assignee: Japan Display Inc., Minato-ku (JP)

(21) Appl. No.: 14/680,227

(22) Filed: Apr. 7, 2015

(30) Foreign Application Priority Data
Apr. 8, 2014 (JP) 2014-079314

(51) Int. Cl. G02F 1/1333; G02F 1/1341; G02F 1/1335

(52) U.S. Cl. CPC G02F 1/133308; G02F 1/133606; G02F 1/1341; G02F 1/133611; G02F 2001/133314; G02F 2001/13332

(57) ABSTRACT

An LCD device according to a group of embodiments comprises: a display panel comprising array and counter substrates, as well as a liquid-crystal layer and a sealing material that are interposed between the substrates adhered with each other; a light illuminating the display panel; a framework covering at least front and end faces of a peripheral part of the display panel; and a resin layer that covers the end faces of the display panel throughout their whole dimensions in a thickness direction of the display panel; and contour of the resin layer on its outside being smoothly curved along the thickness direction, in a section cut in the thickness direction.

### CROSS-REFERENCE TO RELATED APPLICATIONS

This application is based upon and claims the benefit of priority from the prior Japanese Patent Application No. 2014-079314, filed on Apr. 8, 2014; the entire contents of which are incorporated herein by reference.

### FIELD

Embodiments of the present invention relate to a liquid-crystal display (LCD) device, which comprises a display panel and a light source illuminating the display panel. The embodiments particularly relate to an LCD device for vehicle-mounted use or mobile use.

### BACKGROUND

The LCD devices are most typical among flat-panel display (FPD) devices and are widely used as display devices for PCs and TV sets, for computer terminals, for vehicle-mounted display devices such as car navigators and rear-view monitors, and for mobile devices such as smart phones and other mobile phones as well as information terminals or digital assists. In particular, transmissive LCD devices having the backlight devices are widely used. A transmissive or semi-transmissive LCD device is typically comprises: a display panel and its drivers; a backlight device; and a framework receiving the display panel and the backlight device. The display panel comprises an array substrate and a counter substrate, which are adhered to each other through a sealing material, and a liquid crystal layer interposed between these substrates. The display panel of the transmissive LCD device usually has on its front and rear sides, transparent resin sheets such as polarizers and prism sheets. The framework of the LCD device usually includes a part or an element, which covers peripheral areas of the display panel from front side and has L-shaped section. Typically, the framework includes a metallic frame element having L-shaped section, which is called as a bezel cover.

In recent years, requirement for narrowing peripheral non-display area is becoming more and more strict. This tendency is especially prominent in the LCD devices for automobile use and mobile use. Thus, smaller and smaller becomes a distance between a fringe of a view area and an end face of the display panel. At inside of the display panel, a large-width black matrix pattern is arranged to encircle the view area, on inner face (patterned face) of the array or counter substrate, by film forming and patterning, so as to curb light leakage through the peripheral non-display area from the backlight device. The black matrix pattern generally does not extend to reach the end face.

Hence, conventionally, arranged on the peripheral area of the display panel is a light shield such as a light-shielding tape that is attached on front side of the display panel. If the light-shielding tape is a double-faced pressure sensitive adhesive tape, curbed are light leakage through a gap between the display panel and the bezel cover as well as intrusion of dust particles into inside of the LCD device. With further narrowing of the non-display peripheral area, increased is work load for assembling due to increased difficulty in correctly attaching the tape at predetermined position.

In view of the above, JP2008-203875A proposes to arrange a light-shield layer, at between the array and counter substrates of the display panel, on the non-display peripheral area. In detail, following techniques (i) to (iii) are proposed: (i) the black matrix pattern is extended to reach the end face, as indicated in FIG. 3 and paragraph 0027; (ii) “with a pen on general sale, an ink is applied and penetrated by into a recess formed at outside the sealing material 12” at along the end face, at between the array and counter substrates “by capillarity” to form a light-shield layer formed of “a black-colored ink material (as a dried ink)”, as indicated in FIG. 7 and paragraphs 0034-0035; and (iii) “anti-reflecting film 19 is formed” by applying “a black paint having carbon blacks or pigments, for example” on the end faces of the array and counter substrates after filling and sealing of a liquid-crystal material, as indicated in FIGS. 8-9 and paragraphs 0037-0039.

A construction indicated in FIG. 3 of JP2008-203875A would be disadvantageous in that a light-shielding layer formed of metal or resin has to be cut at a time of severing a pair of mother substrates for gang printing, to obtain a number of the display panels. A construction indicated in FIG. 7 of JP2008-203875A would not be adoptable if the sealing material extends to vicinity of the end face of the display panel as a result of further narrowing of the peripheral non-display area; reliable infiltration of the black ink would be difficult because a gap between the array and counter substrates is as narrow as 2 μm to 5 μm for example; and if the liquid-crystal material is injected by a dipping, the black ink is not applicable to a vicinity of an injection port sealed by a resin lump. Meanwhile, a construction indicated in FIGS. 8-9 of JP2008-203875A would not able to curb lights that travel from periphery portion of the backlight device, through an end face of a polarizer at rear side and then frontward; and moreover, utilization efficiency of lights from the backlight device may be decreased at along periphery of the display panel because the black paint absorbs lights that in otherwise would come back to a rear-side substrate, which usually is the array substrate.

In view of the above, embodiments of the invention is aimed to surely curb light leakage through the non-display peripheral area of the display panel, by a simple way and a low cost, in an LCD device having a light source for the display panel.

### BRIEF DESCRIPTION OF THE DRAWINGS

FIG. 1 is a thickness-direction sectional view showing an essential part of an embodiment of the LCD device;

FIG. 2 is a partially cut-out plan view showing an example of over-all construction of the LCD device;

FIG. 3 is a partially cut-out plan view showing another example of over-all construction of the LCD device;

FIG. 4 is a thickness-direction sectional view corresponding to FIG. 1 and showing an essential part of a modified embodiment of the LCD device; and

FIG. 5 is a thickness-direction sectional view corresponding to FIG. 1 and showing an essential part of a comparative example of the LCD device.

### DETAILED DESCRIPTION

An LCD device according to a group of embodiments comprises: a display panel comprising array and counter substrates, as well as a liquid-crystal layer and a sealing material that are interposed between the substrates adhered with each other; alight source illuminating the display panel; a framework covering at least front and end faces of a peripheral part of the display panel; and a resin layer that covers the end faces of the display panel throughout their whole dimensions in a thickness direction of the display panel, except along a terrace part, which is an outward protrusion of the array substrate from the end face of the counter substrate; and a contour of the resin layer on its outside being smoothly curved along the thickness direction, in a section cut in the thickness direction. By such embodiments, light leakage through the peripheral area of the display panel is more reliably curbed, by a simple and low cost manner.

The display panel comprises: array and counter substrates that are closely superposed to each other; a liquid-crystal layer interposed between the substrates; and a sealing material that bonds the substrates together and seals off the liquid-crystal layer from outside. The display panel has a terrace part, which is arranged at least along one side of a rectangle shape of the display panel for example, and by which an end face of the array substrate outwardly deviates from an end face of the counter substrate. Except along the terrace part, the end faces of the array and counter substrates flush with or substantially flush with each other, or are positioned to be superposed or substantially superposed with each other in a plan view as viewed from the thickness direction.

The display panel may have a polygonal or circular shape other than the rectangle shape. An end face of the array substrate may be flush with an end face of the counter substrate, only at along a part of whole periphery of the display panel.

The light source in the transmissive LCD device is arranged at rear side of the LCD panel to illuminate it from the rear side, as a backlight. Meanwhile, a reflective LCD device has a reflective layer such as reflective pixel electrodes at inside of the LCD panel. Thus, in the reflective LCD device, the light source may be omitted or be arranged on front side of the LCD panel to illuminate it from the front side, as a frontlight. The light source as the backlight or the frontlight may be an edge-lit backlight or frontlight that comprises: a lamp or lamps such as LEDs arranged along a fringe of the LCD panel; and a light-guide plate arranged to overlap the view area of the LCD panel. The light source may also be a downright backlight or frontlight that comprises lamps such as LEDs, which are arranged to be covered by the view area.

In preferred embodiments, so far as the side of the rectangle shape of the display panel has such flush arrangement between the end faces of the substrates, the end face of the display panel is covered by the resin layer, throughout such side of the rectangle shape, in the plan view. Throughout such side, the resin layer is arranged throughout whole dimension in the thickness direction, of the end face of the display panel. In other words, throughout such side, the end face of the display panel is completely covered by the resin layer, from a front ridge (top end in the drawing) through a rear ridge (bottom end in the drawing) of the display panel. The resin layer may extend over the front ridge and/or the rear ridge so as to realize a more reliable covering.

The resin layer may cover only a part of an end face of the display panel (to be referred as “panel-end face”), at the side, along which the end faces of the substrates flush with each other. The resin layer does not necessarily cover a whole dimension in the thickness direction, of the panel-end face whereas the resin layer covers preferably most of the whole dimension in the thickness direction and more preferably not less than 80%, further preferably not less than 90% of the whole dimension. The coverage of the panel-end face by the resin layer may vary with varying of positions along the periphery of the display panel.

In a section cut in the thickness direction, contour (excluding a part contacting the display panel, hereafter) of the resin layer consists of a light-scattering geometry that scatters lights emitting from the contour to various directions. The light-scattering geometry is for example, a smooth curve that runs throughout the whole dimension from the top end to the bottom end, in the sectional view. In other words, the contour has no elbow-shaped bend nor straight portion, in the sectional view. Here, fine relief structures for light diffusion should be neglected. In detail, the fine relief structure should be neglected if maximum height Rz of the roughness profile according to JIS B 0601-2013 (ISO4287) is not more than 0.15 mm (150 μm) for example, or not more than 0.1 mm (100 μm) for example. Typically, thickness of the display panel formed of glass substrates is in a range from 0.5 mm to 1.8 mm. The maximum height Rz may be optically measured by 3D measuring laser microscope such as “Olympus LEXT OLS4000”.

The light-scattering geometry of the contour may not only be the smooth curve but also be a random relief structure having the maximum height Rz of the roughness profile more than 0.15 mm or than 0.1 mm.

In preferred embodiments, the contour consists of an outwardly bulging curve, in the section cut in the thickness direction. Also here, fine relief structure having the maximum height Rz not more than 150 μm or 100 μm should be neglected. Such outwardly bulging shape of the contour is advantageous in reinforcing fringe portion of the display panel. In a preferred embodiment, the contour as a whole is shaped as a circular or elliptic arc, in the sectional view. Protrusion dimension of the circular or elliptic arc from the end face of the display panel is in a range of 0.2 to 1 times, more preferably in a range of 0.3 to 0.8 times, of thickness of the display panel at its end face, which means a thickness excluding resin sheets such as polarizers. When the contour is shaped as an elliptic arc, flattening of an ellipse for the elliptic arc may be set as required or appropriately in a range from 0.01-0.7 for example, or in a range from 0.1 to 0.5 in particular.

In preferred embodiments, the contour of the resin layer may be provided with a fine random relief structure for diffused reflection and scattering of lights, or with a light-diffusion layer. The fine random relief structure has the maximum height Rz less than 100 μm or 150 μm and may be formed by surface roughening, which may be abrasive blasting such as sand blasting, or polishing with abrasive fabric embedded with abrasive grains. The surface roughening may also be made by a dry etching technique or by plasma irradiation. The surface roughening might be made as follows: light-curable resin for the resin layer is applied on the panel-end face; then the resin is irradiated with ultraviolet (UV) light; and, before enough curing of the resin, an embossing tool is applied to the contour to form the fine random relief structure. In otherwise, transparent inorganic fillers such as silica powder and/or transparent resin fillers formed of cross-linked polymer such as cross-linked acrylate or cross-linked styrene may be deposited on the contour before enough curing of the resin. Further, coating material having such fillers may be applied on the contour in a manner that the fillers are exposed on the surface. In place of the surface roughening, a light-diffusion layer may be arranged on the contour by using above-mentioned inorganic or resin fillers as light diffusing particles so that light is reflected and diffused to random directions. In such surface roughening or forming the light-diffusion layer, adoptable ones are: light-diffusing particles used in lusterless paints, as well as those used in backlight devices of the LCD devices, such as “Chemisnow” (trademark) MX series as mono-dispersed particles having diameters in a range of 0.8 to 30 μm and “Chemisnow” (trademark) MZ series as moderately-dispersed particles having diameters in a range of 10 to 30 μm, of Soken chemical & Engineering Co.

In preferred embodiments, reflective index of the resin layer covering the end faces of the display panel is substantially same with that of transparent base substrates such as glass substrate in particular, of the array and counter substrates. Hence, deviation of the reflective index between the resin layer and the transparent base substrates is preferably no more than 0.1, more preferably no more than 0.07, further preferably no more than 0.05. By such small deviation of the reflective index, there is enabled curbing of reflection at the interface between the glass substrates and the resin layer. Required extent of minimizing the deviation would vary with product varieties of the LCD devices because the required extent would vary with a distance from the end face of the display panel to the inner fringe of the bezel cover and with thicknesses of the glass substrates. In general, observable light leakage would substantially disappear when reflection at the end face of the display panel is decreased to one thirtieth ( 1/30) for example, and to one hundredth ( 1/100) in particular. Hence, the deviation of the reflection index may appropriately be set so as to diminish the light leakage.

In preferred embodiments, the resin layer covering the end face of the display panel is formed of colorless transparent resin, which is light curable and/or heat curable in particular. Such resin may be at least one of: acrylate resins mainly formed of acrylates and/or methacrylates; urethane acrylate resins, siloxane resins and epoxy resins, for examples. The resin may contain transparent fillers such as silica fine powders if necessary or appropriate. The resin layer may be given with elasticity by using a urethane acrylate resin that are elastic after curing, so as to increase impact resistance of the LCD devices. Adoptable products on sale as the light curable acrylate or urethane-acrylate resins may be “hitaloid” series of Hitachi Chemical Co., Ltd.; and by using reflective index adjusters in this series, reflective index of the resin may be adjusted as required or appropriately to a level equal or substantially equal to that of the glass substrate.

Light transmittance of the resin layer covering the end face of the display panel is preferably not less than 70%, more preferably not less than 80%, and further preferably not less than 90%. High value of the light transmittance is not always required, and lights may be scattered within the resin layer. Despite this, if the resin layer has black pigments for example, light-utilization efficiency of the backlight illumination would be decreased along the periphery of the display panel. This is because the black pigments absorbs some lights of the backlight illumination, which would in otherwise return to inside of the display panel. Nevertheless, the resin for the resin layer might be added with a light-absorbing material for moderating the light transmittance so as to dispose the light-absorbing material at inside of the resin layer; or the light-absorbing material such as black pigments might be included at a portion of a surface part forming the contour; in a manner to surely curb light leakage without remarkably damaging the light-utilization efficiency of the backlight illumination.

In preferred embodiments, the resin layer covering the end faces of the display panel is formed by: applying light-curable and/or heat-curable resin liquid on the end faces; and irradiation with UV or blue light, and/or heating as required. The applying of the resin liquid may be made by a dispenser attached on a robot arm for example, or by dipping the peripheral parts of the display panel in a bath of the resin liquid. After the applying, it is confirmed by inspecting that the resin liquid is fully applied to the end faces in required parts; and then the irradiation and/or the heating is made. After completion of curing of the resin and/or during the curing, the above-mentioned surface roughening or coating of the diffusion layer is made if and as required, on the resin layer. When to realize above-mentioned smooth curve of the contour of resin layer, optimization would be made on viscosity and fluidity of the resin liquid, and temperature at a time of the irradiation, for examples; or in otherwise, a tool is applied to the resin before completion of the curing. Intended shaping of the contour may also be realized by a technique of insert or outsert molding.

In a preferred embodiment, orthogonal dimension of the view area of the LCD device is in a range of 5 to 12 inches; and aspect ratio (length-to-width ratio) of the view area is not less than 1.8 to form a wide view area, so that the LCD device is to be mounted on a vehicle or a transport, for a navigation device such a car navigator or for a rear view monitor, for examples. In other preferred embodiment, the orthogonal dimension of the view area is in a range of 4 to 8 inches; and the aspect ratio is in a range of 1.4 to 1.8, so that the LCD devices are used in smart phones, tablet PCs, mobile game machines as well as information terminals or digital assists.

### EMBODIMENTS

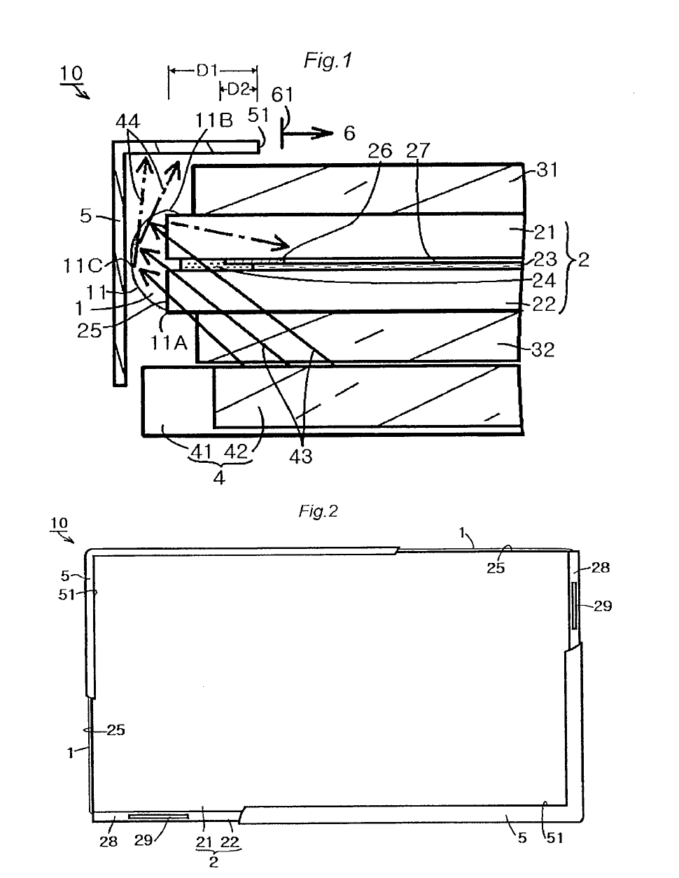

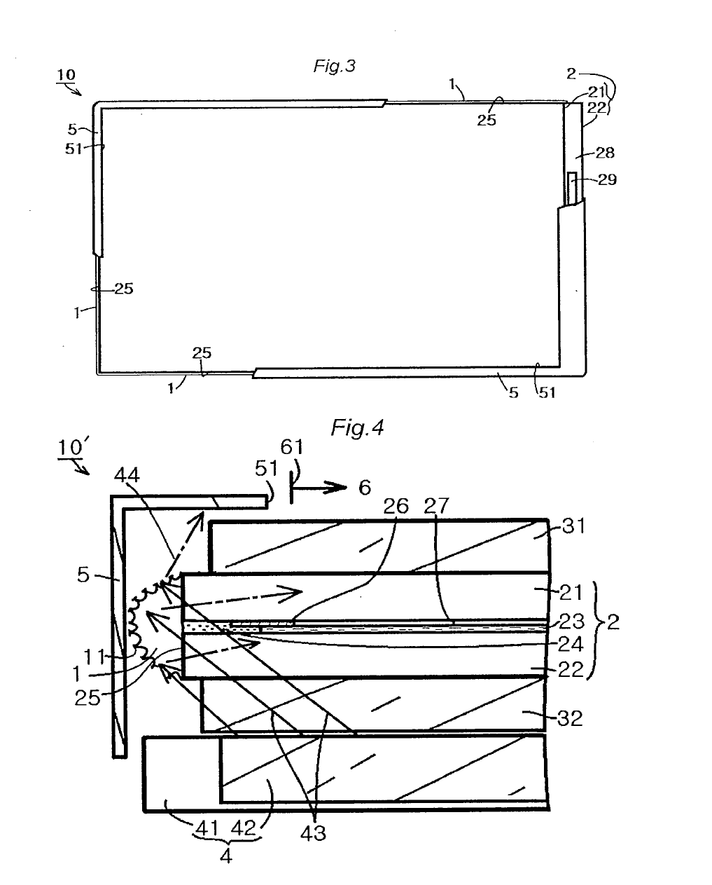

The LCD device of a detailed embodiment of the invention will be described with reference to FIGS. 1-3. FIG. 1 shows an essential part of the LCD device 10 by a sectional view in a thickness direction; FIG. 2 shows an example of overall construction of the LCD, for vehicle-mounted use for example, by a partly cut-out plan view; FIG. 3 shows another example of overall construction of the LCD, for a smart phone for example, by a partly cut-out plan view as in FIG. 3.

Disclosures in respect of the embodiments are only for sake of examples, and modifications easily conceivable by a skilled person in the art without departing from the gist of the invention are included in the scope of the invention as a matter of course. For sake of clarity, drawings may be schematically illustrated in terms of width, thickness and shape of the elements and/or parts differently from the reality. Illustrations in the drawings are mere examples, and are not intended to limit the scope of the invention.

As shown in FIG. 1, Polarizers 31,32 are attached respectively on front face and rear face of the display panel 2. As shown in FIGS. 1-3, the end faces 25 of the display panel 2 (to be referred as panel-end faces 25) are entirely covered by a resin layer 1 that is transparent and outwardly bulged, except along a terrace part 28. In other words, along at least one or two sides among four sides of the rectangular shape of the display panel 2, end faces of the array and counter substrates 21,22 are flush with each other; and along such side of the rectangle shape, the panel-end face 25 is entirely covered by the resin layer 1. Hence, in the thickness-direction sectional view, whole of the panel-end face 25 along such side in flush arrangement is covered by the resin layer 1, from front fringe of the end face of the counter substrate 21 through rear fringe of the end face of the array substrate 22.

As shown in FIG. 1, a contour 11, or an exposed surface other than the interface with the display panel 2, of the resin layer 1 is smoothly curved as outwardly bulged. In particular, the contour 11 is curved as a circular arc, or as an elliptic arc that is almost circular. In a detailed example, a dimension of an outward protrusion of the resin layer 1, from the panel-end face 25 to outward end 11C of the contour 11, is in a range of 0.3 to 0.5 times of the thickness of the display panel 2; and a section of the resin layer 1 as a whole is shaped as a convex lens.

As shown in FIG. 1, fairly small are: a width dimension of non-displaying peripheral area from a fringe 61 of the view area 6 of the display panel 2 to the panel-end face 25; and a distance D1, in the plan view, from inner fringe 51 of a bezel cover 5 to the panel-end face 25. In an illustrated example, the fringe 61 of the view area 6 comes to a boundary between a peripheral black matrix 26 and a color-filter area 27, on a patterned inner face of the counter substrate 21; the peripheral black matrix 26 extends from an area of liquid-crystal layer 23 to an intermediate position between outer and inner fringe of a sealing material 24 so as to expose outside of the intermediate position; and fairly smaller than the distance D1 is a distance D2, in the plan view, from an outer fringe of the peripheral black matrix 26 to the inner fringe 51 of the bezel cover 5. The color filter 27 and the black matrix 26 may be arranged on the array substrate 22, instead of arranging them on the counter substrate 21 as in the above.

In a detailed example, the distance D1 is in a range of 1 mm to 4 mm and the distance D2 is in a range of 20% to 70% of the distance D1. In an example for vehicle-mounted use, a thickness of the display panel 2 is in a range of 1.2 mm to 1.4 mm; and curvature radius of the contour 11 is in a range of 0.6 mm to 3 mm for example. Thus, the dimension of outward protrusion of the resin layer 1 is in a range of 0.3 mm to 0.8 mm for example. In some occasions, a resin lump that seals an injection port for liquid crystal material may outwardly protrude from the panel-end face 25; and then, the dimension of outward protrusion of the resin layer 1 may be set as almost same with that of the resin lump sealing the injection port. When the outer fringe of the sealing material 24 substantially comes to the panel-end face 25, majority of the resin lump sealing the injection port is arranged at outside of the panel-end face 25 if a way of arranging the liquid-crystal materials is an injection through the injection port. Thicknesses of the polarizers 31,32 are in a range of 0.1 mm to 0.3 mm and usually smaller than those of the glass substrates.

In an illustrated detailed example, rear fringe 11A of the contour 11 is positioned substantially at the rear fringe of the panel-end face 25 while front fringe 11B of the contour 11 comes slightly frontward than the front fringe of the panel-end face 25. Thus, a ridge portion around the front fringe of the panel-end face 25 is covered by the resin layer 1. Hence, even with some variation or deviation in resin-applying procedure, front-fringe portion of the panel-end face 25 is surely covered by the resin layer 1. Meanwhile, the outside end 11C of the resin layer 1 contacts with or is positioned to be close to a vertical (LCD-panel's front-rear-direction) wall of the bezel cover 5. As shown in FIGS. 2-3, along the terrace part 28, a distance from the inner fringe 51 of the bezel cover 5 to the end face of the counter substrate 21 becomes relatively large because, on the terrace part 28, arranged are: driver IC chips 29; and wiring groups that run from mount sites of the IC chips 29 to an area covered by the counter substrates 21.

As indicated in FIG. 1, lights 43, which have been emitted from a light-guide plate 42 of the backlight device 4 at near its frame 41 (i.e. resin frame or metal frame) and reached the panel-end face 25, enter into the resin layer 1 that is outwardly bulged, substantially without reflection at the panel-end face 25. In particular, the reflection at the panel-end face 25 would be negligible when reflective index of the glass substrates comprising the display panel 2 is substantially equal with that of the resin layer 1. Then, the lights 44, which have been entered into the resin layer 1 and reached the contour 11, partly goes out through the contour 11 and are partly reflected at the contour 11 back toward inside of the display panel 2. Because the contour 11 is shaped as a circular or elliptic arc in the sectional view, inclination of the contour 11 varies with LCD-panel's front-rear-direction position or height in the sectional view; and hence, inwardly reflected lights are scattered to various directions. Consequently, non-negligible light leakage is curbed at around the fringe 61 of the view area 6, especially at between the fringe 61 of the view area 6 and the inner fringe 51 of the bezel cover 5 even when small are the distance D1 from the inner fringe 51 of the bezel cover 5 to the panel-end face 25 as well as the a ratio, to this distance D1, of the distance D2 from the inner fringe 51 to the black matrix 26.

In a modified embodiment illustrated in FIG. 1, the contour 11 has been subjected to surface roughening by abrasive blasting or polishing with an abrasive fabric, to obtain the maximum height Rz of the roughness profile not more than 25 μm for example. By such surface roughening, the lights reflected at the contour 11 and the lights outwardly passing through the contour 11 would be further scattered in random directions; and hence, the light leakage would be more reliably curbed.

FIG. 4 is a thickness-direction sectional view schematically showing essential portion of an LCD device 10′ according to a modified embodiment, in which a relatively coarse, random relief structure is formed on the contour 11. For example, maximum height Rz of the roughness profile of the relief structure is in a range of 100 μm to 150 μm (0.1 mm to 0.15 mm), which is achievable by an embossing technique or by sand blasting with relatively coarse blasting media. By such random relief structure, lights are scattered in random directions to more reliably curb the light leakage.

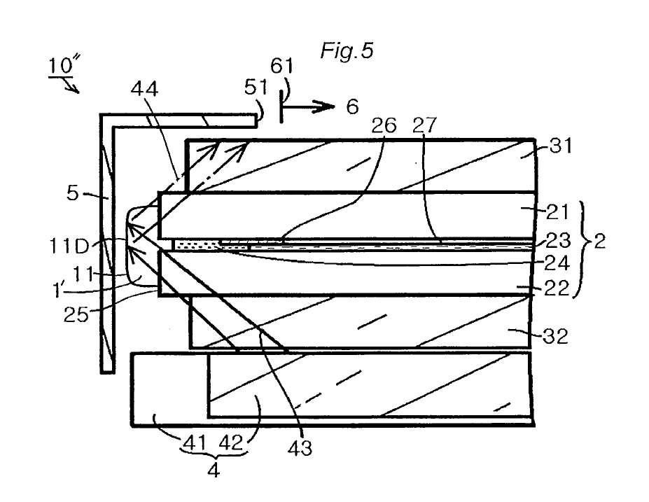

FIG. 5 is a thickness-direction sectional view schematically showing essential portion of an LCD device 10″ according to a comparative example. A resin layer 1′, which is arranged on the panel-end face 25 as well, does not cover front-end and rear-end parts of the panel-end face 25 and have a substantially D-shaped cross section in a manner that outside face of the contour 11 makes a flat surface 11D that is parallel with the panel-end face 25. Lights 43 from the backlight device 4 reaches the flat surface 11D, and thus, lights 44 reflected at the flat surface 11D would be in a non-scattered manner and would tend to travel toward the view area. Moreover, lights from the backlight device 4 would also be reflected at not-covered parts of the panel-end face 25 and would thus tend to travel toward the view area 6. Hence, curbing of the light leakage would not be sufficient.

What is claimed is:

1. A liquid-crystal display (LCD) device comprising:
a display panel comprising array and counter substrates, as well as a liquid-crystal layer and a sealing material that are interposed between the substrates adhered with each other;
a light source illuminating the display panel;
a framework covering at least front and end faces of a peripheral part of the display panel; and
a resin layer that covers the end faces of the display panel throughout their whole dimensions in a thickness direction of the display panel; and
a contour of the resin layer on its outside being smoothly curved along the thickness direction, in a section cut in the thickness direction.

2. The LCD device according to claim 1, wherein the resin layer is transparent.

3. The LCD device according to claim 1, wherein reflex index of the resin layer is substantially same with that of each transparent base substrate of the array and counter substrates.

4. The LCD device according to claim 1, wherein the contour is shaped as a circular or elliptical arc, in the section.

5. The LCD device according to claim 1, wherein the contour has a random relief structure.

6. The LCD device according to claim 1, wherein the resin layer comprises at its inside or surface, a light-absorbing material.

7. The LCD device according to claim 1, wherein a dimension of an outward protrusion of the resin layer is in a range of 0.3 to 0.8 times of thickness of the display panel.

8. The LCD device according to claim 1, wherein front end of the resin layer is positioned to be more frontward than front ridge of the end face of the display panel so that vicinity of the front ridge is covered by the resin layer.

9. The LCD device according to claim 1, wherein the end faces of the display panel are entirely covered by the resin layer, except along a terrace part, in which end faces of the array and counter substrates are arranged as deviated from each other.

10. The LCD device according to claim 1, wherein a black matrix pattern encircling a view area of the display panel extends from an area of the liquid-crystal layer to an intermediate position between inner and outer fringes of the sealing material so as to expose outside of the intermediate position.

11. The LCD device according to claim 10, wherein a distance from inner fringe of the framework to outer fringe of the black matrix pattern is in a range of 20% to 70% of a distance from the inner fringe of the framework to the end face of the display panel.

12. The LCD device according to claim 1, wherein the resin layer has along the contour, a light-diffusing layer that comprises inorganic and/or resin fillers as light-diffusing particles.

13. A liquid-crystal display (LCD) device comprising:
a display panel comprising array and counter substrates, as well as a liquid-crystal layer and a sealing material that are interposed between the substrates adhered with each other;
a light source illuminating the display panel;
a framework covering at least front and end faces of a peripheral part of the display panel; and
a resin layer that covers the end face of the display panel at least part of a dimension of the end face in a thickness direction of the display panel; and
a contour of the resin layer on its outside being smoothly curved along the thickness direction, in a section cut in the thickness direction.

14. A liquid-crystal display (LCD) device comprising:
a display panel comprising array and counter substrates, as well as a liquid-crystal layer and a sealing material that are interposed between the substrates adhered with each other;
a light source illuminating the display panel;
a framework covering at least front and end faces of a peripheral part of the display panel; and
a resin layer that covers the end faces of the display panel throughout their whole dimensions in a thickness direction of the display panel; and
a contour of the resin layer on its outside having a light-scattering geometry, in a section cut in the thickness direction.
